(19) United States
(12) Patent Application Publication
(10) Pub. No.: US 2016/0262059 A1
(43) Pub. Date: Sep. 8, 2016

(54) METHODS AND APPARATUS FOR TRANSITIONING A UE BETWEEN BASE STATIONS

(71) Applicant: Luminate Wireless, Inc., Cupertino, CA (US)

(72) Inventors: Amit Butala, Sunnyvale, CA (US); Atul Salhotra, Santa Clara, CA (US); Brett Schein, Mountain View, CA (US)

(21) Appl. No.: 14/690,684

(22) Filed: Apr. 20, 2015

Related U.S. Application Data
(63) Continuation-in-part of application No. 14/688,139, filed on Apr. 16, 2015.
(60) Provisional application No. 62/129,721, filed on Mar. 6, 2015.

(51) Int. Cl. H04W 36/00

(52) U.S. Cl. CPC H04W 36/0005; H04W 36/08

(57) ABSTRACT

Methods and apparatus for supporting efficient transitioning of a UE device from a source to destination base station are described. Various embodiments are well suited for use in an environment in where there may be PCI confusion. The handover mechanism is used to: (i) deliver context transfer information corresponding to the UE to one or more potential target base stations and to be available for use by other base stations and (ii) to force an initial handover attempt to fail via the use of intentionally faulty radio resource information. Following the initial handover attempt failure, the UE establishes a successful connection with the destination base station using valid radio resource information which was recovered via a received wireless broadcast signal.

### RELATED APPLICATIONS

The present application claims the benefit of U.S. Provisional Patent Application Ser. No. 62/129,721 filed on Mar. 6, 2015 and U.S. Utility patent application Ser. No. 14/688,139 on Apr. 16, 2015 which is hereby expressly incorporated by reference in its entirety.

### FIELD

Various embodiments relate to handover methods and apparatus and, more particularly, to methods and apparatus which allow for efficient transitioning of a UE between base stations in a communications network.

### BACKGROUND

Ever increasing demand by mobile device users for larger amounts of data from the wireless cellular systems to which they connect has fueled the need for increasing amounts of cellular infrastructure, in particular a dramatically increased density of wireless access points (APs). To meet the increasing demands, there is a trend to substantially increase the number of available low power small cell APs, e.g., small cell Home eNodeBs (HeNBs). However, as typical cell size decreases, the frequency of handover for a user equipment (UE) device between APs corresponding to different cells tends to increase.

In LTE, every cell is assigned a physical layer (PHY) identifier called Physical Cell Identity (PCI), used primarily for scrambling PHY data to help separate signals transmitted from different cells. There are only 504 PCIs available to be used throughout the network. For a macro network deployment, the neighboring eNBs, due to their larger RF footprint, typically have a unique PCI. In a dense small cell deployment, on the other hand, there could be many cells, within the footprint of a macro eNB, sharing the same PCI. Assuming that the HeNBs in a Small Cell System are assigned PCIs from a dedicated pool, which likely includes significantly smaller than 504 PCIs, allocated by the cellular Network Operator, many of the PCIs from this dedicated pool are reused among various small cells. Since many small cells use the same PCI, a fundamental problem called PCI confusion during handovers arises when a UE reports PCI alone in its measurement data when indicating handover to desired target cells.

A known solution to address this problem is for the source eNB to request the UE to use the 3GPP standardized reportCGl mechanism whenever the UE reports a strong RF measurement from a small cell with one of the dedicated PCIs. When this mechanism is used, the UE reports back to the source eNB the target HeNB cell PLMN ID (Public land mobile network identifier), 28 bit Cell Identity, and TAC (Tracking area code). This combination of information is sufficient to uniquely identify the target HeNB within the small cell network, and to enable the EPC (Evolved Packet Core) to route the Handover Request message to the target HeNB. While such an approach may reduce the chances of PCI confusion, there is, however, a system level tradeoff when using this mechanism, in terms of requiring additional UE RF measurements and UE to eNB control plane signaling. In addition using this mechanism imposes additional requirements for the source eNB. Additionally, a UE may end up being unable to connect to the originally chosen target base station (BS) due to RF conditions and may end up needing to connect to a nearby small cell.

In view of the above discussion it should be appreciated that there is a need for new improved methods and apparatus that would eliminate or reduce the PCI confusion problem. It would be advantageous if the new methods and apparatus would address the PCI confusion problem and provide for efficient transitioning of a UE device between base stations.

### SUMMARY

Various features related to improved methods and apparatus for transitioning a UE between base stations in systems with dense deployment of small cells are described. Various features of the invention described herein facilitate efficient techniques for transitioning the UE device between base stations. The methods and apparatus of the present invention can be used in embodiments where PCI confusion exists and/or in embodiments where it is desirable to group a number of cells as corresponding to a common handoff identifier for purposes of handover whether or not they share a common PCI. In dense systems Physical Cell Identifier (PCI) confusion can arise in situations where two or more small cells are using the same PCI. This can cause complications for the source base station (e.g., eNB or macro base station) in identifying a target access point, e.g., small cell HeNB, to which a UE device wishes to handover to.

At least some embodiments of the present invention provide solutions to the PCI confusion issue without requiring a macro eNB to rely on a reported CGI (Global cell identifier) functionality to zero in on the desired target HeNB.

The methods and apparatus are particularly well suited for use in systems including multiple small cells, e.g., pico or femto cells, where handovers of mobile devices may occur between APs, e.g., between macro eNB and small cell HeNBs.

In some embodiments, the handover mechanism is used: (i) to communicate context transfer information corresponding to a UE to prepare potential target base stations and to have the context transfer information stored, e.g., locally, and readily available to be used by other base stations in the vicinity; and (ii) to force an initial handover attempt failure, e.g., via faulty radio resource information communicated in a handover request acknowledgment. The UE will, following the initial handover attempt failure, subsequently attempt to establish a radio connection with a destination base station using recovered broadcast valid radio resource information.

In some embodiments, one or more potential target base stations, e.g., small base stations using the same PCI, are identified, and a handover request corresponding to a UE device is communicated to the one or more target base stations, said handover request including an indicator indicating that the handover request should be responded to with intentionally faulty radio resource information which if used by the UE will result in a failure to connect. Exemplary intentionally faulty radio resource information includes a T304 element value which is too small to allow connection establishment to be successful or incorrect RACH configuration information. The target base station generates and sends a handover request acknowledgment including faulty radio resource information; and the faulty radio resource information is communicated to the UE device. The UE device uses the intentionally faulty radio resource information and fails to connect to a target base station, as intended. After the failure to connect, the UE device connects to a destination base station using received broadcast radio resource information, which is valid radio resource information. In some embodiments, in accordance with an implemented protocol, the UE device does not try to reconnect to the source base station following a handover failure in which faulty radio resource information was provided. In some embodiments, in accordance with an implemented protocol, the UE device retries to attach to a base station at least once using parameters (valid radio resource information) acquired from broadcast transmissions received from a base station, said retry following the initial handover failure using the faulty radio resource information.

An exemplary handover method, in accordance with some embodiments, includes operating a target network device, e.g., a target base station, to receive a handover request corresponding to a UE; and determining, at the target network device, whether said handover request should be responded to with valid radio resource information or intentionally faulty radio resource information which if used by the UE to attempt a connection to the target base station will result in a failure to connect. In various embodiments, the exemplary method further includes sending, in response to determining that the handover request should be responded to with intentionally faulty radio resource information, a handover acknowledgment including intentionally faulty radio resource information which if used by the UE to attempt a connection to a target base station will result in a failure to connect.

While various embodiments have been discussed in the summary above, it should be appreciated that not necessarily all embodiments include the same features and some of the features described above are not necessary but can be desirable in some embodiments. Numerous additional features, embodiments, and benefits of various embodiments are discussed in the detailed description which follows.

### BRIEF DESCRIPTION OF THE FIGURES

FIG. 1 is a drawing of an exemplary communications system including both macro and small cell base stations in accordance with an exemplary embodiment.

FIG. 2 is drawing illustrating exemplary signaling in a handover from a macro base station to a small cell base station, in which a HeNB GW facilitates efficient handover, in accordance with an exemplary embodiment.

FIG. 3A is a first part of flowchart of an exemplary handover method in accordance with an exemplary embodiment.

FIG. 3B is a second part of flowchart of an exemplary handover method in accordance with an exemplary embodiment.

FIG. 3 comprises the combination of FIG. 3A and FIG. 3B.

FIG. 4 is a drawing of an exemplary base station, e.g., a small base station such as a HeNB, implemented in accordance with an exemplary embodiment.

FIG. 5 is an assembly of modules which may be included in the exemplary base station of FIG. 4.

FIG. 6 is a drawing including exemplary signaling corresponding to the example of FIG. 2 and using the method of flowchart of FIG. 3.

### DETAILED DESCRIPTION

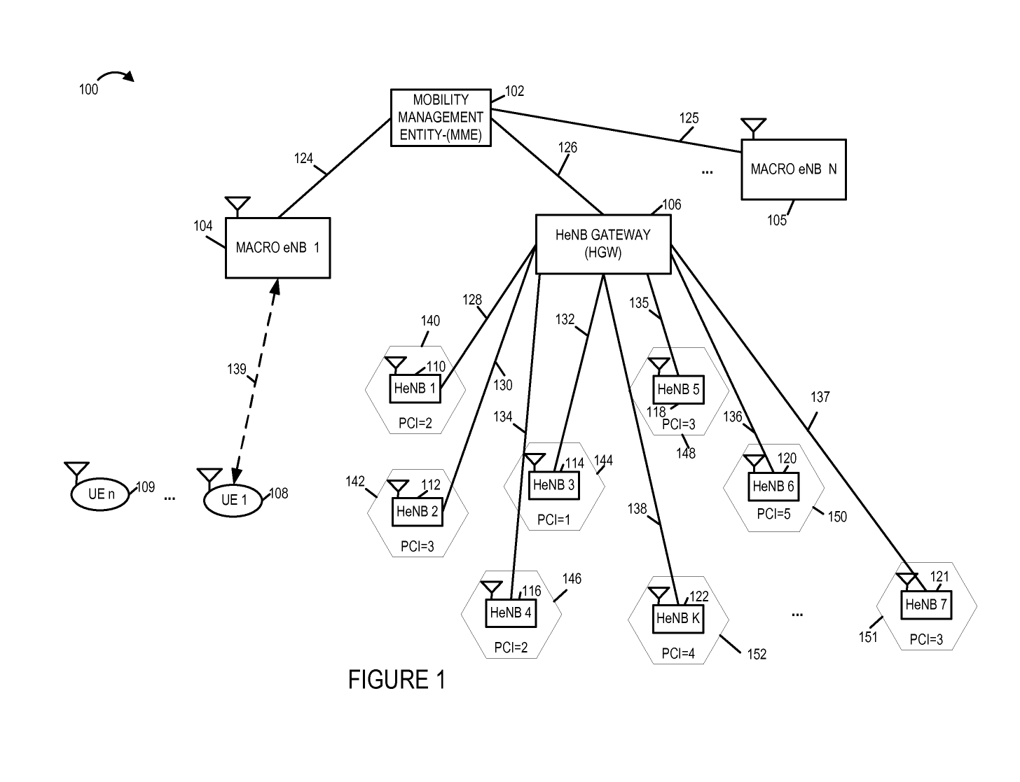

FIG. 1 is a drawing of an exemplary communications system 100 in accordance with an exemplary embodiment. Exemplary communications system 100 includes a mobility management entity (MME) 102, a plurality of macro base stations (macro eNB 1 104, . . . , macro eNB N 105), a Home eNB gateway (HeNB GW (HGW)) 106, and a plurality of small cell base stations (HeNB 1 110, HeNB 2 112, HeNB 3 114, HeNB 4 116, HeNB 5 118, HeNB 6 120, HeNB 7 121, . . . , HeNB K 122), corresponding to a plurality of small cells (small cell 1 140, small cell 2 142, small cell 3 144, small cell 4 146, small cell 5 148, small cell 6 150, small cell 7 151, . . . , small cell K 152, respectively). Small cell base stations are sometimes referred to as small base stations. System 100 further includes a plurality of user equipment (UE) devices, e.g., mobile nodes, (UE 1 108 . . . , UE n 109). The MME 102 is coupled to the macro base stations (macro eNB 1 104, . . . , macro eNB N 105), via links (124, . . . , 125), respectively. The MME 102 is coupled to the HeNB Gateway (HGW) 106 via link 126. The small cell base stations (HeNB 1 110, HeNB 2 112, HeNB 3 114, HeNB 4 116, HeNB 5 118, HeNB 6 120, HeNB 7 121, . . . , HeNB K 122) are coupled to the HeNB GW 106 via links (128, 130, 132, 134, 135, 136, 137, . . . , 138), respectively. The UE devices (UE 1 108, . . . , UE n 109) may move throughout the system and be coupled to a macro base station, e.g., a macro eNB, or a small cell base station, e.g., a HeNB. In this example, UE 1 108 is shown coupled to macro eNB 1 104, via wireless link 139. Macro eNB 1 104 may desire to transition UE 1 108 to a small base station. In various embodiments, the UE 1 108 is transitioned to one of the small base stations using a technique in which intentionally faulty radio resource information is communicated to the UE resulting in an initial failure to connect in the handover attempt, and a subsequent connection is established using valid radio resource information which was received by the UE in a received broadcast transmission.

While in various examples the hand in techniques, also sometimes referred to as handover techniques, are described in the context of what in 3GPP terminology is often referred to as an S1-based handover, it should be appreciated that the same techniques and methods are also applicable to X2-based handover. Furthermore, the techniques while useful in 3GPP type systems are not limited to being used in such systems and may be used with other types of systems as well.

In some embodiments, the macro eNBs (macro eNB 1 104, . . . , macro eNB N 105) are part of a macro E-UTRAN (Evolved UMTS Terrestrial Radio Access Network). In some embodiments, the plurality of HeNBs (HeNB 1 110, HeNB 2 112, HeNB 3 114, HeNB 4 116, HeNB 5 118, HeNB 6 120, HeNB 7 121, . . . , HeNB K 122) are part of a Local E-UTRAN.

A macro eNB is, e.g., cellular base station of a wireless radio network, e.g., a 4G network. The HeNBs are, e.g., small cell, e.g., LTE femto cell, base stations. A UE device may be coupled to one or more eNBs or HeNBs, e.g., via one or more wireless communications links For example, UE 1 108 is coupled to macro eNB 1 104 via wireless link 139.

The MME 102 communicates with the macro eNB 104 and HGW 106 via one or more S1-MME interfaces. HGW 106 communicates with the HeNBs via a S1-MME interface and/or via a S1U interface. The HGW 106 acts as a concentration point for the HeNBs (110, 112, 114, 116, 118, 120, 121, . . . , 122). The HGW 106 helps shield the core network including the MME 102 from the burden of overseeing a very large number of HeNBs. The HGW 106 acts as a data and control traffic concentrator. Instead of many separate Si connections corresponding to different HeNBs, the MME 102 sees a single S1 connection from the HGW 106.

The hexagonal region around each of the HeNBs indicates the cell region corresponding to each of the HeNBs, with each cell being assigned a PCI. Small cell 1 140 corresponds to HeNB 1 110 and is assigned PCI=2. Small cell 2 142 corresponds to HeNB 2 112 and is assigned PCI=3. Small cell 3 144 corresponds to HeNB 3 114 and is assigned PCI=1. Small cell 4 146 corresponds to HeNB 4 116 and is assigned PCI=2. Small cell 5 148 corresponds to HeNB 5 118 and is assigned PCI=3. Small cell 6 150 corresponds to HeNB 6 120 and is assigned PCI=5. Small cell 7 151 corresponds to HeNB 7 121 and is assigned PCI=3. Small cell K 152 corresponds to HeNB K 122 and is assigned PCI=4. Various HeNBs in the plurality of HeNBs (110, 112, 114, 116, 118, 120, 121, . . . , 122) share the same PCI as can be seen in FIG. 1. For example as illustrated in FIG. 1, HeNB 1 110 and HeNB 4 116 share the same PCI (PCI=2); HeNB 2 112, HeNB 5 118, and HeNB 7 121, share the same PCI (PCI=3).

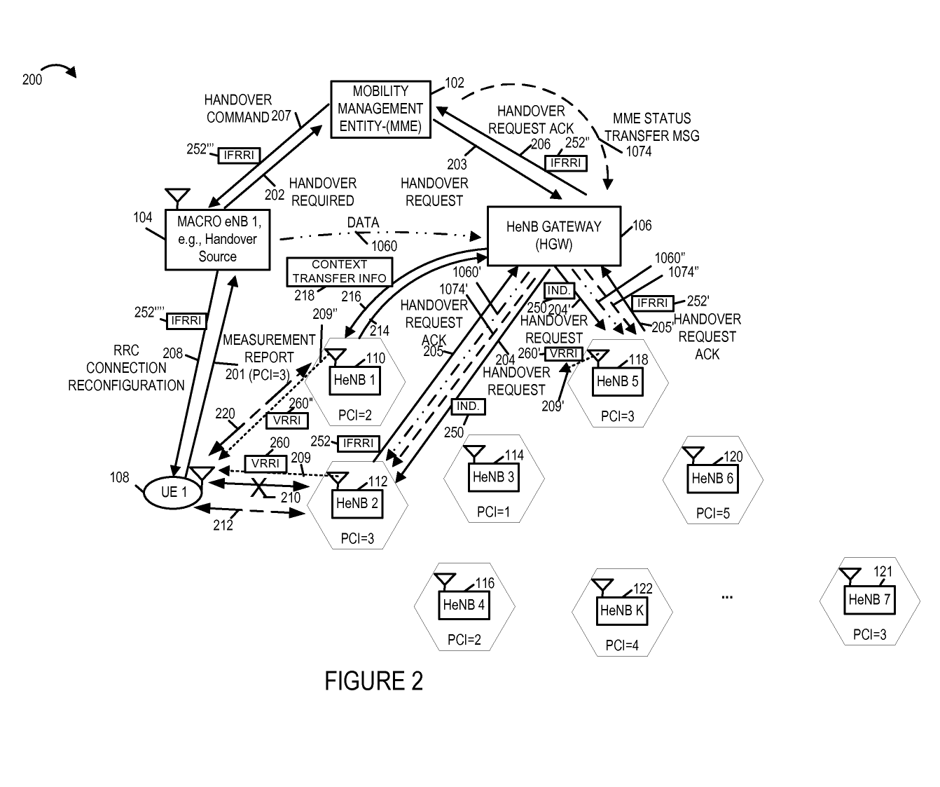

FIG. 2 is a drawing 200 illustrating signaling between some of the elements of the exemplary communications system of FIG. 1, in accordance with an exemplary embodiment. The signaling (indicated by the arrows in FIG. 2) may occur as part of implementing a transition of a UE device from the macro eNB 104 to a target HeNB. The signaling shown in drawing 200 relates to signaling exchange between various elements participating in a transition from macro eNB to the target HeNB.

In accordance with one aspect of some embodiments a configuration at the macro eNB 104 is employed and neighbor cell information is used to eliminate the PCI confusion issue. The UE device 108 when desiring handover to a desired target base station, e.g., a target HeNB, reports RF signal strength measurements along with the PCI corresponding to the target HeNB in a measurement report to the macro eNB 104 as illustrated by signaling arrow 201. In accordance with one aspect of the invention the macro eNB 104 is supplied configuration information that maps each PCI allocated to small cell HeNBs to a virtual ECGI (E-UTRAN Cell Global Identifier) and the TAI (Tracking Area Identity) served by the HeNB gateway enabling the routing of handover related messages to the gateway controlling the small cell HeNBs, e.g., which in the illustrated example is the HGW 106. In some embodiments neighbor cell information generated in accordance with one feature of the invention is utilized in addition to the information regarding the PCIs corresponding to the HeNBs that the HGW 106 is serving to generate a list of potential target HeNBs with a given PCI, e.g., the PCI reported by the UE device 108 in the measurement report.

In various embodiments and examples described herein a source eNB is described as a macro eNB. This is the primary intention. However, the methods described herein apply if the source is another HeNB, rather than a macro eNB, and whether or not that other HeNB is under an HGW or not. For example, the hand in/hand over techniques can, and in some embodiments are, used when the source eNB is an HeNB from another vendor than a target HeNB.

Source macro eNB 1 104 sends handover required signal 202 to MME 102. MME 102 generates and sends handover request signal 203, e.g., including a virtual ECGI, to HGW 106. HGW 106 receives the handover request signal 203. HGW 106 decides whether to indicate that the handover should be responded to with intentionally faulty radio resource information (IFRRI) or valid radio resource information (VRRI), for example based on the virtual ECGI included in the handover request message 203 sent by the MME 102. In this example, HGW 106 decides to indicate that the handover should be responded to with intentionally faulty radio resource information. The HGW 106 sends Handover request signal 204 including handover type indicator 250 to HeNB 2 112 and handover request signal 204′ including handover type indicator 250 HeNB 5 118. Handover type indicators 250 indicates a type of handover request that should be responded to with intentionally faulty radio resource information. HeNB 2 112 and HeNB 5 118 both correspond to PCI=3. In some embodiments, handover request signal 204 and handover request signal 204′ are unicast signals. In other embodiments, handover request signal 204 and handover request signal 204′ are the same signal which is a multicast signal. In various embodiments, there are 2 or more small cell base stations attached to HGW 106 which share PCI=3, and a subset of small cell base stations using PCI=3 are selected, to be prepared for handover, with the subset being selected based on proximity information with regard to the source macro base station 104, e.g., small cell base stations within the cell corresponding to macro eNB 1 104 or adjacent to macro eNB 1 104. In this example, consider that HeNB 2 112, which uses PCI=3, and HeNB 5 118, which uses PCI=3, satisfy the criteria to be included in the selected subset to be prepared for handover; further consider that HeNB 7 121, which uses PCI=3, does not satisfy the criteria to be included in the selected subset to be prepared for handover, e.g., HeNB 7 121 is very far away from macro eNB 1 104. In various embodiments, the handover request of signals (204, 204′) includes a cellular radio network temporary identifier (C-RNTI) in a field of the handover request.HeNB 2 112 and HeNB 5 118 receive handover requests (204, 204′), respectively, and process the received handover requests (204, 204′), respectively. HeNB 2 112 determines whether the handover request 204 should be responded to with valid radio resource information or intentionally faulty radio resource information. HeNB 2 112 checks and determines that the handover request 204 includes handover type indicator 250 indicating a type of handover that should be responded to with intentionally faulty radio resource information. HeNB 5 118 checks and determines that the handover request 204′ includes handover type indicator 250 indicating a type of handover that should be responded to with intentionally faulty radio resource information. The small base stations (HeNB 2 112, HeNB 5 118), in response to determining that the handover request should be responded to with intentionally faulty radio resource information, generate and send a handover request acknowledgment (205, 205′) including intentionally faulty radio resource information (IFRRI) (252, 252′) to HGW 106. In some embodiments IFRRI 252 is the same as IFRRI 252′. In some embodiments, the intentionally faulty radio resource information includes at least one of a T304 element with an intentionally small value or incorrect RACH configuration information, said intentionally faulty radio resource information intended to cause an initial failure to connect when used by a UE device during handover. In some embodiments, the T304 element corresponds to a 3GPP LTE T304 timer. The timer is used by the UE, and the timer is started when the UE begins attempting to connect to the target base station. The target base station includes the value the UE should use for this timer in its handover request acknowledgement message, where it is called the T304 message element. If the timer expires before the UE successfully connects to the target base station, the UE considers the handover connection attempt to have failed.

While in some embodiments the HeNBs, such as HeNB 2 112, are responsible for generating the handover request acknowledgment, in some embodiments, as an alternative, a HGW or HGW HandIn Router which is located between the serving base station and handover target generates a handover request acknowledgment with intentionally faulty radio resource information (IFRRI). In one such embodiment the HGW or HGW HandIn Router generating the acknowledgement makes the decision whether or not the acknowledgement is to include faulty radio resource information. The decision made by the HGW or HGW Handin Router to provide valid or fault radio resource information maybe, and sometimes is, based on a handover type indicator 250 indicating whether the handover request corresponds to a type of handover that should be responded to with intentionally faulty radio resource information. By having the HGW or HGW Handin Router provide the handover acknowledgement it is possible to speed up the response back to the UE since a response can be sent even before the handover request message reaches a HeNB. This approach allows the system to begin moving the UE device to the target base station without waiting for a HeNB to provide an acknowledgment. In some such embodiments while the acknowledgement is the same or similar to that generated by a HeNB, it is the HGW or HGW HandIn Router that makes the decision whether faulty radio resource information is to be provided and responds when it is decided that faulty radio resource information is to be provided. The handover request message may still be communicated to one or more HeNBs but acknowledgements, if any, generated by the HeNBs maybe, and normally will be, discarded by the HGW and/or HGW Handin Router which sent the acknowledgment to the handover request message.

In various embodiments, the HeNBs are configured to implement a handover acceptance policy, when the handover request indicates a type of handover request that should be responded to with intentionally faulty radio resource information, which requires the base station to initially accept a handover request and each of the UE's E-RABs if the HeNB can accept at least one of the UE's E-RABs. Thus, in various embodiments, handover request ack (205, 205′) indicates that HeNBs (102, 108) will accept each of the UE 1 108's E-RABs.

HGW 106 receives handover request acknowledgments (205, 205′). In various embodiments, HGW 106 generates and sends handover request Ack 206 including intentionally faulty radio resource information 252″, in response to the first received handover request ack, which may be signal 205 or 205′. In some embodiments, information IFRRI 252″ is a copy of one of IFRRI 252 or IFRRI 252′. In some such embodiments, the HGW 106 does not send an additional ack to MME 102 in response to a second received ack.

In some embodiments, HGW 106 sends data, which was forwarded from source macro eNB 1 104 that is to be delivered to UE 108 and a MME status transfer message to HeNB 2 112 and HeNB 5 118, e.g., in response to received acks (205, 205′), respectively. For example, data to be delivered to the UE 108 is communicated in signal 1060 from macro eNB 1 104 to HGW 106, and is sent from HGW 106 to HeNB 2 112 and HeNB 5 118 via signals (1060′, 1060″), respectively. Continuing with the example, a MME status transfer message is sent in signal 1074 from MME 102 to HGW 106, and the MME status transfer message is then sent from HGW 106 to HeNB 2 112 and HeNB 5 118 via signals (1074′, 1074″), respectively. This approach of preparing target small base stations (112, 118) facilitates lossless transitioning of UE 1 108 from the source eNB 1 104.

MME 102 receives handover request acknowledgment 206, and in response, generates and sends handover command signal 207 including intentionally faulty radio resource information 252′″ to macro eNB 1 104. In some embodiments, IFRRI 252′″ is a copy of IFRRI 252″. Macro eNB 1 104 receives signal 207, and sends RRC Connection Reconfiguration 208 including IFRRI 252″″ to UE 1 108, which receives signal 208. In some embodiments IFRRI 252′ is a copy of IFRRI 252′″. In some other embodiments, IFRRI 252″″ is generated based on information included in IFRRI 252′″.

Various small base stations (112, 118, 110) broadcast radio resource configuration information (valid radio resource information (VRRI) 260, VRRI 260′, VRRI 260″) in signals (209, 209′, 209″), respectively, which can be used by a UE in the proximity of the small base station to establish a radio connection with a small base station, when this is expected to be used by the UE, e.g., following the expected initial handover failure due to the intentionally faulty radio resource information 252″″ received in the RRC connection reconfiguration message 208.

In this example, consider that UE 1 108 is in the vicinity of small base station HeNB 2 112. UE 1 108 completes attempts to complete handover from macro eNB 1 104 to small base station HeNB 2 112 using the intentionally faulty radio resource information 252″″. This results, as intended in a failure to connect, as indicated by the large X 210 on the bi-directional arrow between UE 1 108 and HeNB 2 112.

Thus, the handover of the UE was not successfully completed to HeNB 2 112 or one of the other small cell base stations prepared for handover, e.g., because of the use of intentionally faulty radio resource information. Following the initial handover attempt failure, the UE 108 tries to establish a radio connection with one of the base stations, e.g., one of the small cell base stations in its vicinity. In some embodiments, the UE follows a cell selection process to determine the next base station to attempt to establish a radio connection. (The 3GPP LTE specification defines this as the UE behavior upon failing to connect to the target base station.) In some embodiments, a parameter is included in the generated handover request acknowledgments (205, 205′), which is subsequently communicated to the UE 108, e.g., in signal 208 indicating that following an initial handover failure, the UE should not try to connect to the source base station, e.g., the UE should select a target that excludes the source base station. In some embodiments, a parameter is included in the generated handover request acknowledgments (205, 205′), which is subsequently communicated to the UE 108, e.g., in signal 208 indicating that the UE should retry to attach to a base station at least once using parameters (valid radio resource information) acquired from broadcast transmissions received from a base station, said retry following the initial handover failure using the faulty radio resource information.

Consider one alternative scenario, following the failed handover attempt using intentionally faulty radio resource information 252″″, as indicated by X 210, UE 1 108 decides to try to connect to HeNB 2 112 using valid received radio resource information 260 which was received in broadcast signal 209. Consider that radio connection 212 is successfully established. HeNB 2 112 has stored context transfer information corresponding to UE 1 108 which was previously stored following being received in received handover request 204.

Consider a second alternative scenario, following the failed handover attempt using intentionally faulty radio resource information 252″″, as indicated by X 210, UE 1 108 decides to try to connect to HeNB 1 110 using valid received radio resource information 260″ which was received in broadcast signal 209″. Consider that radio connection 220 is successfully established. HeNB 1 214 sends a request for context transfer information in signal 214 to HGW 106, which has a stored copy of the context transfer information which was previously communicated to the selected handover target base stations (112, 118). HGW 1 106 generates and sends signal 216 including the context transfer information 218 to HeNB 1 110.

Some of the features of the various embodiments are described below. In some embodiments, a one time minimal configuration is employed at a macro eNB, and an intelligent SON (self-organizing network) solution is utilized to arrive at the set of potential target HeNBs based on the desired cell's PCI indicated by the UE in its measurement report.

In some embodiments, the configuration at the macro eNB maps every PCI allocated to a Small Cell System to a virtual ECGI (vECGI) and the TAI (served by the small cell system HeNB GW) enabling the routing of handover related messages to the GW controlling the small cells. In various embodiments, based on neighbor cell information provided by SON (per Macro eNB) and the knowledge of PCIs of HeNBs it is serving, the HGW comes up with a list of potential target HeNBs with a particular PCI.

These two elements are separable and variants are possible. In some embodiments, it is not necessary to use SON to help identify HeNBs close to the source eNB. In some embodiments, the one time minimal configuration is global, e.g., same vECGIs are used for every macro eNB. In some embodiments, the one time minimal configuration is local, e.g., different vECGIs are used for different macro eNBs. Alternatively, in some embodiments, the minimum configuration is updated instead of being a one time configuration could be dynamic, updated over time. In some embodiments, a single vECGI is used so the HGW does not differentiate reported PCIs. Thus it should be appreciated that the macro configuration could be, and in some embodiments is, dynamic, e.g., updated over time. For example, in some embodiments the mapping from PCI to vECGI is changed for one or more reasons. For example, the mapping may change due to the addition of a new PCI used by small cells in the system. In the case of the use of a new PCI, another PCI to vECGI entry in the macro cell configuration may be, and in some embodiments is, generated. One part of the mapping information in some embodiments includes a PCI to TAI or (virtual) TAI, rather than PCI to virtual ECGI in particular embodiments. In various embodiments a handover request includes both a TAI and an ECGI in the handover request message. The TAI includes (TAC, PLMN ID). The ECGI includes (ECI, PLMN ID). In some embodiments the reported PCI is determined based on a virtual TAC (within TAI) or virtual ECI (within ECGI) that corresponds to the UE device reported PCI.

In some embodiments, lossless handover is facilitated by enabling the HGW to buffer MME Status Transfer message and data forwarded by the source eNB and multicasting to all the target HeNBs being prepared or sending individual unicast messages to all the target HeNBs being prepared.

In some embodiments, an air-interface identifier to be used for the incoming UE, in form of C-RNTI, is made available to all HeNBs being prepared using novel messaging. In this context, instead of or in addition to using intentionally faulty radio resource configuration, the UE could be given a coordinated C-RNTI—as we have described here. When the UE attempts to connect with the target base station using this C-RNTI, the target base station knows that it is supposed to fail the initial handover, e.g., by intentionally not responding when the UE attempts to connect with this C- RNTI. Note that if the UE was given IFRRI, the procedure would not typically get so far as the target base station receiving the C-RNTI from the UE and deciding to fail out the procedure. But it is technically possible depending on exactly what faulty configuration was provided in the IFRRI.

In some embodiments, a dedicated pool of C-RNTIs is created and maintained per PCI for the UEs whose handin results in PCI confusion.

In some embodiments, it is possible to return the C-RNTI back to this Handin pool by inducing an intracell handover to the target HeNB itself. Alternatively, a C-RNTI can be returned to the pool upon the next natural handover to another cell (internal or external).

The pool of C-RNTIs may or may not be per PCI, depending on whether external eNBs are configured with different vECGIs for different PCIs. In some embodiments, a pool of C-RNTIs maintained per PCI may be the same set of C-RNTI numbers. They are just allocated, used, and returned to the pool independently per PCI.

In some embodiments, a UE Context Fetch procedure is used which can, and sometimes does, aid in the HeNB recovering the UE context from HGW, in the event that the UE selects an HeNB, which is not one of the selected set of small cells HeNBs being prepared for handover, as part of RRC Connection ReEstablishment. In some embodiments, the RRC Connection ReEstablishment procedure is invoked after the UE is unable to successfully synchronize to the desired target HeNB and the handover involving multi cell preparation fails.

In some embodiments, the deployment involves multiple HGW network elements, and an additional hierarchical layer is introduced in the Small Cell System including HGW HandIn Routers. In some embodiments, the HGW HandIn Routers are the first point of entry into the small cell system for the handover preparation messages initiated from macro eNB. In order to facilitate this approach, unique TACs or TAIs are assigned to these routers and have these available at the Macro as part of one time static configuration. It is assumed that mutually exclusive set of TACs are used for HGWs and the HGW HandIn Routers in the small cell system. Effectively, the configuration at Macro eNB is modified to include TAI served by the HGW HandIn Routers. The number of HGW HandIn routers to deploy is choice of the implementer. For instance, in one exemplary embodiment a single HGW Handin Router is used as the frontend for all handins, using a single global TAI and the traffic can be distributed or routed any way the implementer wants behind that front end. In a 3GPP compatible embodiment unique TAIs are assigned to these HGW HandIn Routers. In 3GPP LTE, TAI=TAC+PLMN ID. Routing from MME to HGW is done by TAI in such an embodiment, according to 3GPP specification (as opposed to by TAC).

Also note that in some embodiments the macro eNBs are programmed with a table mapping (small cell) PCI to pairs of (TAI and vECGI). In one implementation, different vECGIs are used to indicate different reported PCIs, and the MME uses the TAI to route the message to the appropriate HGW or HGW HandIn Router. In another embodiment, different TAIs (via their TACs) are used to indicate different reported PCIs, and the MME can use the vECGI to route the message to the appropriate HGW or HGW HandIn Router. In some systems both of these approaches are used, with the particular approach used for a given message depending on the capability of the MMEs with which handoff interaction takes place.

In another exemplary implementation, one router is deployed per PCI assigned. In general the deployment of HGW HandIn Routers in the small cell system can be, and sometimes is, scaled independently of the number of PCIs available.

In some embodiments, a single HGW HandIn Router or, perhaps, a few HGW HandIn Routers separated by different TAIs are deployed. In some embodiments, the number of HGW HandIn Routers deployed is completely independent from the number of and actual values of the small cell PCIs.

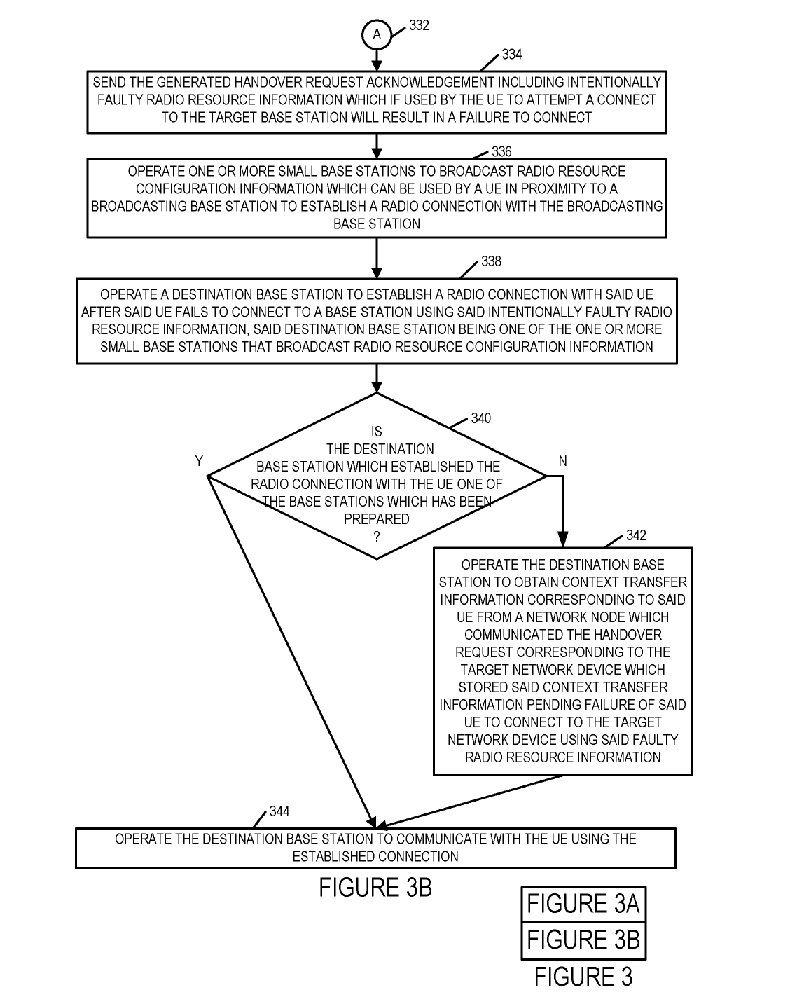

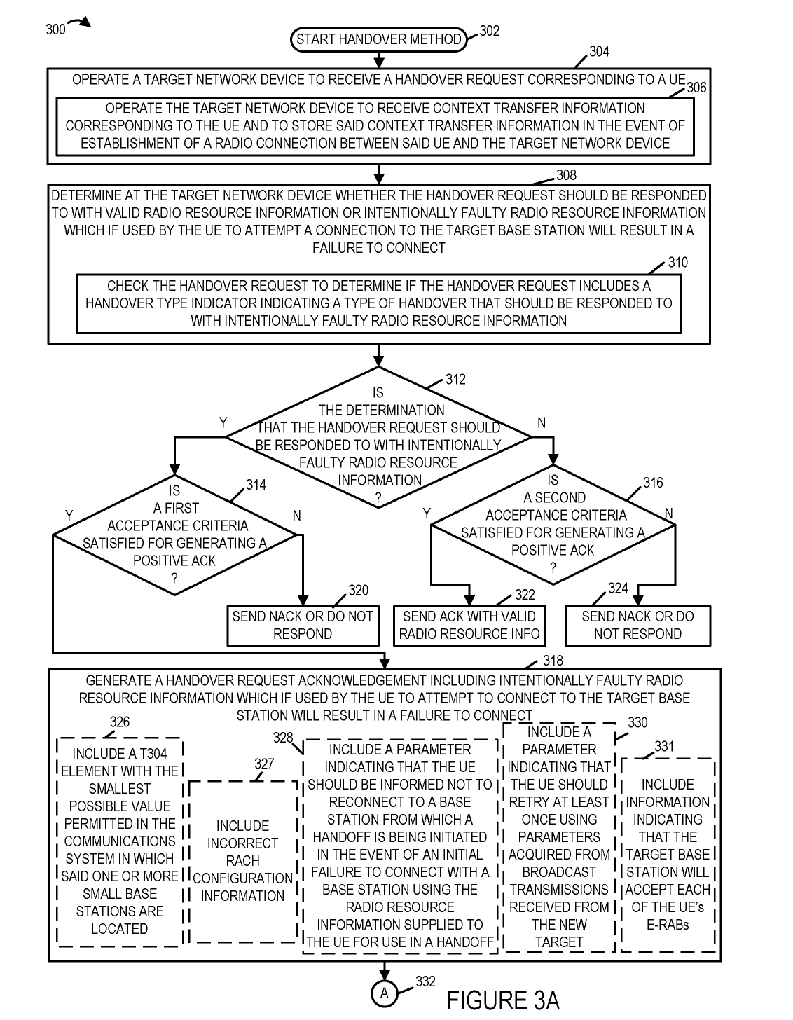

FIG. 3, comprising the combination of FIG. 3A and FIG. 3B, is a flowchart 300 of an exemplary handover method in accordance with an exemplary embodiment. Operation of the exemplary method starts in step 302 and proceeds to step 304.

In step 304 a target network device, e.g., a target base station, is operated to receive a handover request corresponding to a UE. In some embodiments, the target network device is one of one or more small base stations. In LTE embodiments the small base stations maybe and sometimes are HeNBs. In some embodiments, the target base station is one small base station in a set of small base stations, e.g., using the same PCI, which are selected to receive the handover request corresponding to the UE.

Step 304 includes step 306 in which the target network device receives context transfer information corresponding to the UE and stores said context transfer information to be used in the event of establishment of a radio connection between the UE and the target network device.

Operation proceeds from step 304 to step 308. In step 308, the target network device determines whether the handover request should be responded to with valid radio resource information or intentionally faulty radio resource information which if used by the UE to attempt a connection to the target base station will result in a failure to connect, if the target network device decides to send a positive acknowledgment in response to the received handover request. Step 308 includes step 310 in which the target network device checks the handover request to determine if the handover request includes a handover type indicator indicating a type of handover that should be responded to with intentionally faulty radio resource information.

In some embodiments, a handover type indicator in a field of the handover request provides an indication that the handover request is a first type that should be responded to with intentionally faulty radio resource information or a second type that should be responded to with valid radio resource information. In some embodiments, a handover type indicator in a field of the handover request indicating that the handover is to be responded to with intentionally faulty radio resource information is included when the handover message is a first type that should be responded to with intentionally faulty radio resource information; and the handover type field is not included in the handover message when the handover message is a second type which should be responded to with valid radio resource information. In some embodiments, the handover request of the first type, which should be responded to with intentionally faulty radio resource information, is sent as part of a multi-target handover request in which there is expected to be PCI confusion, e.g., due to multiple small base stations in a local vicinity using the same PCI. In some embodiments, the handover request of the second type, which should be responded to with valid radio resource information, is sent as part of a single target handover request in which there is no PCI confusion.

Operation proceeds from step 308 to step 312. In step 312 if the determination is that the handover request should be responded to with intentionally faulty radio resource information, then operation proceeds from step 312 to step 314;

otherwise, operation proceeds from step 312 to step 316. In step 314, the target network device determines if a first acceptance criteria is satisfied for generating a positive acknowledgment in response to the received handover request. In one embodiment, the first criteria is that the target network device is able to accept at least one E-RAB corresponding to the UE device. In step 314, if the target network device determines that the first criteria is not satisfied, then operation proceeds from step 314 to step 320, in which the target network device sends a NAK. However, if in step 314, the target network device determines that the first criteria is satisfied, then operation proceeds from step 314 to step 318. In step 318, the target network device generates a handover request acknowledgment including intentionally faulty radio resource information which if used by the UE to attempt to connect to the target base station will result in a failure to connect.

Returning to step 312, in step 312 if the determination is that the handover request should be responded to with valid radio resource information, then operation proceeds from step 312 to step 316. In step 316, the target network device determines if a second acceptance criteria is satisfied for generating a positive acknowledgment in response to the received handover request. In various embodiments, the second acceptance criteria is more restrictive than the first acceptance criteria. In one embodiment, the second acceptance criteria corresponds to a normal admission policy in which available bandwidth and priorities, e.g., corresponding to different UEs and/or different E-RABs, are taken into consideration. In step 316, if the target network device determines that the second criteria is not satisfied, then operation proceeds from step 316 to step 324, in which the target network device sends a NAK. However, if in step 316, the target network device determines that the second acceptance criteria is satisfied, then operation proceeds from step 316 to step 322. In step 322, the target network device generates a handover request acknowledgment including valid radio resource information.

Returning to step 318, in various embodiments, step 318 includes one or more or all of steps 326, 327, 328, 330 and 331. In step 326, the target network device includes in the handover request acknowledgment a T304 element, e.g., a timer value, with the smallest possible value permitted in the communications system in which said one or more small base stations are located. The T304 time says how long to try before giving up on the connection attempt. Thus the handover connection can be forced to fail by not giving the UE enough time to connect. In some embodiments, the target network device includes in the handover request acknowledgment a T304 element, e.g., a timer value, with a sufficiently small value, e.g., not necessarily the smallest possible value, such that a connection attempt to any of the target base stations in the communications system is expected to fail when the T304 value is used by the UE to attempt the handover.

In step 327 the target network device includes in the handover request acknowledgment incorrect RACH configuration information. In some embodiments, the incorrect RACH configuration information includes one or more or all of the following: mismatched PRACH frequency offset, a power ramping step=0, a low preambleInitialReceive TargetPower setting, such as −120 dBm, a mismatched Root Sequence Index, a mismatched PRACH config Index, a mismatched C-RNTI, a mismatched target PCI, a mismatched DL bandwidth, a mismatched antenna ports count, a mismatchaed ul CyclicPrefixLength, and a mismatched NCC. Mismatch here means that the value used by the target BS is different from the value that the UE is told the target BS is using. In one example, incorrect RACH configuration information communicated in the handover request acknowledgment tells the UE to use a preamble which the target network device is instructed or configured to ignore resulting in a failure to connect. Thus the target network device specifies information used to generate a preamble which will be deemed invalid and rejected by the target network device resulting in a failure to connect.

In step 328, the target network device includes in the handover request acknowledgment a parameter indicating that the UE should be informed not to reconnect to a base station from which the handover is being initiated in the event of an initial failure to connect with a base station using the radio resource information supplied to the UE for used in a handover, e.g., the source base station is eliminated from the possible base station candidates for the next attempt to connect following the initial failure due to the intentionally faulty radio resource information.

In step 330 the target network device includes in the handover request acknowledgment a parameter indicating that the UE should retry to attach to a base station at least once using parameters (valid radio resource information) acquired from broadcast transmissions received from a base station, said retry following the initial handover failure using the faulty radio resource information. Thus, the UE is informed to try to attach to a UE selected target with broadcast parameters, which should include valid radio resource information, following the initial failure to connect due to the use of the intentionally faulty radio resource information.

In step 331 the target network device includes in the handover request acknowledgment information indicating that the target base station will accept each of the UE's E-RABs.

Operation proceeds from step 318, via connecting node A 332, top step 334, in which the target network device sends the generated handover acknowledgment including intentionally faulty radio resource information which if used by the UE to attempt connecting to the target base station will result in a failure to connect. Operation proceeds from step 334 to step 336.

In step 336, one or more small base stations are operated to broadcast radio resource configuration information which can be used by a UE in proximity to a broadcasting base station to establish a radio connection with a broadcasting base station. Operation proceeds from step 336 to step 338. In step 338 a destination base station is operated to establish a radio resource connection with said UE after said UE fails to connect to a base station using said intentionally faulty radio resource information, said destination base station being one of the one or more small base stations that broadcast radio resource configuration information. Operation proceeds from step 338 to step 340.

In step 340, if the destination base station which established the radio connection with the UE is not one of the base stations which have been prepared, e.g., a base station to which context transfer information corresponding to the UE has been previously communicated as part of preparation, then operation proceeds from step 340 to step 342; otherwise operation proceeds from step 340 to step 344.

In step 342, the destination base station obtains context transfer information corresponding to said UE from a network node, e.g., a MME or e.g., an HGW or HGW HandIn Router, which communicated the handover request corresponding to the target network device which stored said context transfer information pending failure of said UE to connect to the target network device using said faulty radio resource information. Operation proceeds from step 342 to step 344.

In step 344 the destination base station is operated to communicate with the UE using the established connection.

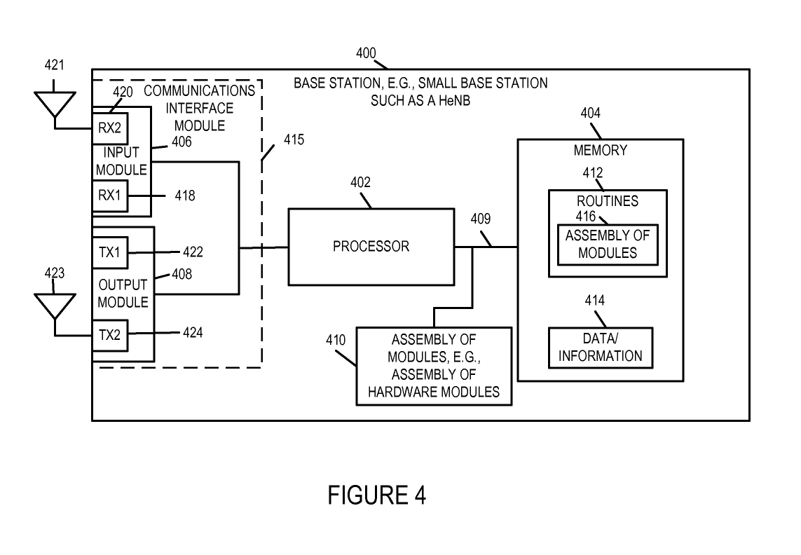

FIG. 4 is a drawing of an exemplary small cell base station 400, e.g., a HeNB, in accordance with an exemplary embodiment. Exemplary small cell base station 400 is one of the HeNBs of FIGS. 1-4, e.g., HeNB 2 112 of any of FIGS. 1-2, HeNB 1 320 of FIGS. 3-4, and/or a small cell base station, e.g., a HeNB, implementing one or more steps of the method of FIG. 3.

Small cell base station 400, e.g., a HeNB, includes a processor 402, e.g., a CPU, memory 404, and an assembly of modules 410, e.g., an assembly of hardware modules, coupled together via a bus 409 over which the various elements may exchange data and information. Small cell base station 400 further includes an input module 406 and an output module 408, which are coupled to the processor 402. In various embodiments the input module 406 and the output module 408 are included as part of a communications interface module 415. In various embodiments, communications interface module 415 includes interfaces for communication with different types of devices, e.g., HGWs, HGW HandIn Routers, UEs, SGWs, a PGWs, DNSs, MMEs, management devices, etc. and/or supporting a plurality of different communications protocols. The input module 406 and/or output module 408 may, and in some embodiments do, include a plurality of different ports and/or interfaces. Input module 406 includes a plurality of receivers including a first receiver RX 1 418 and a second receiver RX 2 420, which is a wireless receiver, coupled to receive antenna 421. Output module 408 includes a plurality of transmitters including a first transmitter TX 1 422 and a second transmitter TX 2 424, which is a wireless transmitter, coupled to transmit antenna 423. In some embodiments, the same antenna is used for transmit and receive. In some embodiments, multiple antennas are used for receive and multiple antennas are used for transmit

Small cell base station 400 receives signals including messages via input module 406. Exemplary received signals include a handover request including an indicator indicating that the handover request should be responded to with intentionally faulty radio resource information which if used by a UE to attempt to connect to the base station will result in a failure to connect. Small cell base station 400 transmits signals including messages via output module 408. Exemplary transmitted signals include a handover request response acknowledgment including intentionally faulty radio resource information which if used by a UE to attempt to connect to the base station will result in a failure to connect and a wireless broadcast signal communicating valid radio resource configuration information which may be used by a UE to attempt to connect to the base station.

Memory 404 includes routines 412 and data/information 414. Routines 412 includes an assembly of modules 416.

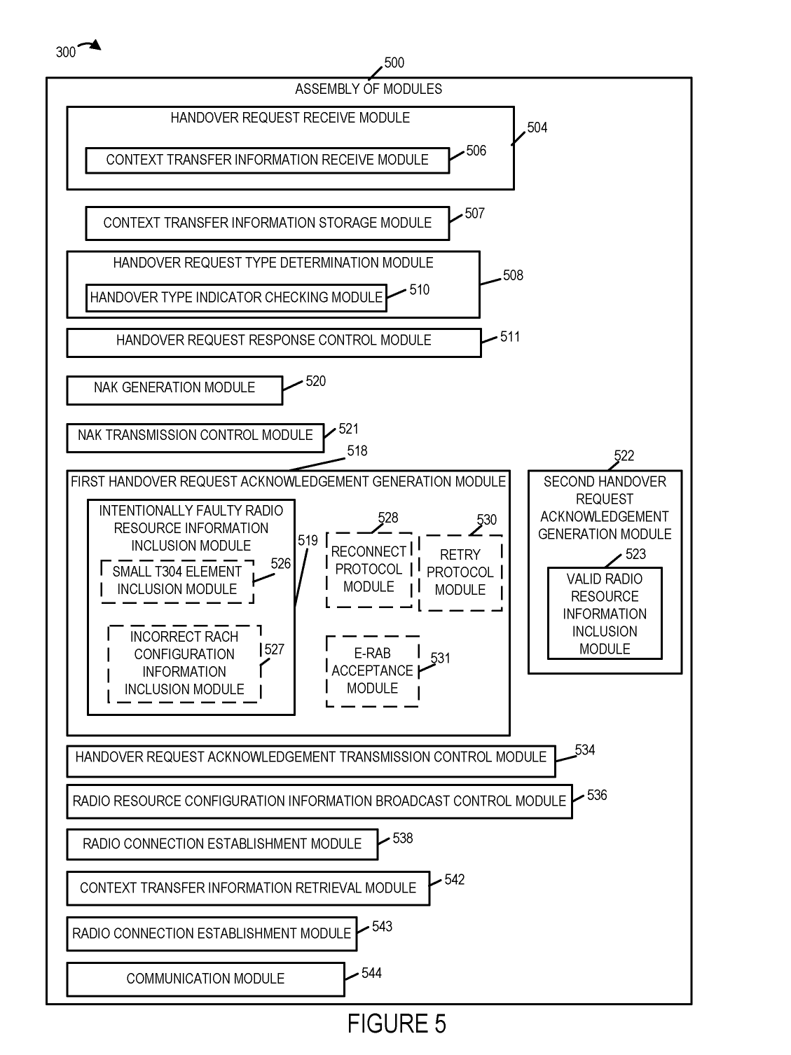

FIG. 5 is a drawing of an assembly of modules 500 which may be included in an exemplary base station, e.g., a small base station such as an exemplary HeNB, in accordance with an exemplary embodiment. In some embodiments, the base station including assembly of modules 500 may be, and sometimes is, a target network device to which a handover request is directed. In some embodiments, the base station including assembly of modules 500 may be, and sometimes is, one a plurality of target network devices to which a handover request is directed. Assembly of modules 500 can be, and in some embodiments is, used in the base station 400. The modules in the assembly of modules 500 can, and in some embodiments are, implemented fully in hardware within the processor 402, e.g., as individual circuits. The modules in the assembly of modules 500 can, and in some embodiments are, implemented fully in hardware within the assembly of modules 410, e.g., as individual circuits corresponding to the different modules. In other embodiments some of the modules are implemented, e.g., as circuits, within the processor 402 with other modules being implemented, e.g., as circuits within assembly of modules 410, external to and coupled to the processor 402. As should be appreciated the level of integration of modules on the processor and/or with some modules being external to the processor may be one of design choice. Alternatively, rather than being implemented as circuits, all or some of the modules may be implemented in software and stored in the memory 404 of the small cell base station 400, with the modules controlling operation of small cell base station 400 to implement the functions corresponding to the modules when the modules are executed by a processor, e.g., processor 402. In some such embodiments, the assembly of modules 500 is included in the memory 404 as assembly of modules 416. In still other embodiments, various modules in assembly of modules 500 are implemented as a combination of hardware and software, e.g., with another circuit external to the processor providing input to the processor 402 which then under software control operates to perform a portion of a module's function. While shown in the FIG. 4 embodiment as a single processor, e.g., computer, it should be appreciated that the processor 402 may be implemented as one or more processors, e.g., computers.

When implemented in software the modules include code, which when executed by the processor 402, configure the processor 402 to implement the function corresponding to the module. In embodiments where the assembly of modules 500 is stored in the memory 404, the memory 404 is a computer program product comprising a computer readable medium comprising code, e.g., individual code for each module, for causing at least one computer, e.g., processor 402, to implement the functions to which the modules correspond.

Completely hardware based or completely software based modules may be used. However, it should be appreciated that any combination of software and hardware, e.g., circuit implemented modules may be used to implement the functions. As should be appreciated, the modules illustrated in FIG. 5 control and/or configure the base station 400 or elements therein such as the processor 402, to perform the functions of corresponding steps illustrated in the method of one or more of the signaling drawings of FIG. 1-2 and FIG. 6 and/or the flowchart of FIGS. 3. Thus the assembly of modules 500 includes various modules that perform functions of corresponding steps of one or more of FIGS. 1-3 and FIG. 6.

Assembly of modules 500 includes a handover request receive module 504 including a context transfer information receive module 506, a handover request type determination module 508, a handover request type determination module 508, a handover request response control module 511, a NAK generation module, a NAK transmission module 521, a first handover request acknowledgement generation module 518, a second handover request acknowledgment generation module 522, a generated handover request acknowledgment transmission control module 534, a radio resource configuration information broadcast control module 536, a radio connection establishment module 538, a context transfer information retrieval module 542, a connection establishment module 543, and a communication module 544.

Handover request receive module is configured to receive a handover request corresponding to a UE. Handover request receive module 504 includes a context transfer information receive module 506. Context transfer information receive module is configured to receive context transfer information corresponding to the UE, e.g., which is communicated as part of the handover request. Context transfer information storage module 508 is configured to store received context transfer information corresponding to the UE.

Handover request type determination module 508 is configured to determine whether the handover request should be responded to with valid radio resource information or intentionally faulty radio resource information, which if used by the UE to attempt a connection to the target base station will result in a failure to connect. Handover request type determination module 508 includes a handover type indicator checking module 510 configured to check said handover request to determine if the handover request includes a handover type indicator indicating a type of handover request that should be responded to with intentionally faulty radio resource information.

Handover request response control module 511 determines if the base station should respond to the handover request with a positive acknowledgment or with one of a negative acknowledgment or be controlled to refrain from sending an acknowledgment. In some embodiments, depending upon the type of handover request different acceptance criteria are used to determine when to send a positive acknowledgment. In some embodiments, if the type of handover is the type that is to be responded to with intentionally faulty radio resource information, the handover request response control module 511 determines to send a positive acknowledgment if the base station can accept at least one of the UE's E-RABs. In some embodiments, if the type of handover is the type that is to be responded to with valid radio resource information, the handover request response control module 511 determines to send a positive acknowledgment based on a typical acceptance policy taking into consideration priorities and bandwidths corresponding to different competing users, devices, and/or flows.

First handover request acknowledgment generation module 518 is configured to generate a handover request acknowledgment including intentionally faulty radio resource information in response to a determination, e.g., by module 508, that the handover request should be responded to with intentionally faulty radio resource information. First handover request acknowledgment generation module 518 includes an intentionally faulty radio resource information inclusion module 519 configured to include intentionally faulty radio resource information in the generated handover request acknowledgment. Intentionally faulty radio resource information inclusion module 519 includes one or both of small T304 element inclusion module 526 and incorrect RACH configuration inclusion module 527.

In some embodiments, small T304 element inclusion module is configured to include in the generated handover request acknowledgment a T304 element (timer value) with the smallest possible value permitted in the communications system in which the base station is located. In some other embodiments, small T304 element inclusion module is configured to include in the generated handover request acknowledgment a T304 element a sufficiently small value permitted which, when used by the UE will cause a failure to connect with any of the alternative base stations in the communications system to which the UE may try to connect as part of the handover.

Incorrect RACH configuration information inclusion module 527 is configured to include in the generated handover request acknowledgment incorrect RACH configuration information. In some embodiments, the incorrect RACH configuration information includes one or more or all of the following: mismatched PRACH frequency offset, a power ramping step=0, a small value for preambleInitialReceive TargetPower, such as −120 dBm, a mismatched Root Sequence Index, a mismatched PRACH config Index, a mismatched C-RNTI, a mismatched target PCI, a mismatched DL bandwidth, a mismatched antenna ports count, a mismatched ul CyclicPrefixLength, and a mismatched NCC. Mismatch here means that the value used by the target BS is different from the value that the UE is told the target BS is using. In one example, incorrect RACH configuration information communicated in the handover request acknowledgment tells the UE to use a preamble which the target network device is instructed or configured to ignore resulting in a failure to connect. Thus the target network device specifies information used to generate a preamble which will be deemed invalid and rejected by the target network device.

In some embodiments, first handover request acknowledgment generation module 518 includes one or more or all of: a reconnect protocol module 528, a retry protocol module 530 and a E-RAB acceptance module 531. Reconnect protocol module 530 is configured to include in said generated handover request acknowledgment a parameter indicating that the UE should be informed not to reconnect to a base station from which a handover is being initiated in the event of an initial handover failure to connection with a base station using the radio resource information supplied to the UE for use in a handover. Retry protocol module 530 is configured to include in the handover request acknowledgment a parameter indicating that the UE should retry to attach to a base station at least once using parameters, e.g., valid radio resource information, acquired from broadcast transmissions received from a base station, said retry following the initial handover failure using the faulty radio resource information. E-RAB acceptance module 531 is configured to include in the handover request acknowledgment information indicating the base station will accept all the E-RABs of the UE.

Second handover request acknowledgment generation module 522 is configured to generate a handover request acknowledgment including valid radio resource information in response to a determination by handover request type determination module 508 that the received handover request should be responded to with valid radio resource information. Second handover request acknowledgment generation module 522 includes a valid radio resource information inclusion module 523. Valid radio resource information inclusion module 523 is configured to include valid radio resource information in the generated handover request acknowledgment.

Handover request acknowledgment transmission control module 524 is configured to control a transmitter to transmit the generated handover request acknowledgment generated by first handover request acknowledgment generation module 518 or second handover request acknowledgment generation module 522. Handover request acknowledgment transmission control module 524 is configured to control the transmitter to send, in response to a determination by module 508 that the handover request should be responded to with intentionally faulty radio resource information, a generated handover request acknowledgment including faulty radio resource information which if used by the UE to attempt a connection to the target base station will result in a failure to connect.

Radio resource configuration information broadcast control module 536 is configured to broadcast valid radio resource information which may be used by received and used the UE to establish a connection, e.g., following a failure to connect using the intentionally faulty radio resource information which was communicated via the acknowledgment.

Context transfer information retrieval module 538 is configured to obtain stored context transfer information corresponding to a UE, e.g., a second UE, from a network node, e.g., a HeNB Gateway, which communicated a handover request corresponding to the UE, e.g., the second UE, to a target network device. Context transfer information retrieval module 538 is used to obtain context transfer information, e.g., locally available context transfer information, e.g., from a HGW, in a case where the base station was not one of the target devices which were selected for handover and to which the handover request was sent.

Radio connection establishment module 543 is configured to establish a radio connection with said UE after said UE fails to connect to a target base station using said intentionally faulty radio resource information, the connection being established based on the use of broadcast valid radio resource information. Communication module 544 is configured to communicate with said UE using the established radio connection.

In some embodiment, an exemplary base station, e.g., base station 400 of FIG. 4, includes a handover request receive module configured to receive a handover request corresponding to a UE; and a handover request type determination module configured to determine whether said handover request should be responded to with valid radio resource information or intentionally faulty radio resource information which if used by the UE to attempt a connection to the target base station will result in a failure to connect. In some embodiments, said base station is a target network device to which said handover request is directed. In some embodiments, said base station is one of a plurality of target network devices to which said handover request is directed. IN various embodiments, said handover request type determination module includes: a handover request type indicator checking module configured to check said handover request to determine if the handover request includes a handover type indicator indicating a type of handover request that should be responded to with intentionally faulty radio resource information. In some embodiments, the base station includes a handover request acknowledgment generation module configured to generate, in response to determining that the handover request should be responded to with intentionally faulty radio resource information, a handover request acknowledgment including intentionally faulty radio resource information which if used by the UE to attempt a connection to a target base station will result in a failure to connect; and a handover request acknowledgment transmission control module configured to control the base station to send, in response to determining that the handover request should be responded to with intentionally faulty radio resource information, the generated handover request acknowledgment including intentionally faulty radio resource information which if used by the UE to attempt a connection to a target base station will result in a failure to connect. In various embodiments, the base station includes a context transfer information receive module configured to receive context transfer information corresponding to the UE; and a context information storage module configured to store said context transfer information in the event of establishment of a radio connection between said UE and the base station. In some embodiments, the base station includes a radio resource configuration information broadcast control module configured to broadcast radio resource configuration information which can be used by a UE in proximity to the base station to establish a radio connection with the base station. In various embodiments, said base station is a small base station. In some embodiments, wherein said generated handover acknowledgment, sent in response to determining that the handover request should be responded to with intentionally faulty radio resource information, includes a T304 element with the smallest possible value permitted in the communications system in which said base station is located, the base station includes: a small T304 element inclusion module configured to include in said generated handover request acknowledgment a T304 element with the smallest possible value permitted in the communications system in which said base station is located. IN some embodiments, wherein said generated handover request acknowledgment, sent in response to determining that the handover request should be responded to with intentionally faulty radio resource information, includes incorrect RACH configuration information, the base station includes: an incorrect RACH configuration information inclusion module configured to include in said generated handover request acknowledgment incorrect RACH configuration information. In some embodiments, the base station includes a radio connection establishment module configured to establish a radio connection with said UE after said UE fails to connect to a target base station using said intentionally faulty radio resource information. In some embodiments, the base stations includes a context transfer information retrieval module configured to obtain stored context transfer information corresponding to a second UE from a network node which communicated a handover request corresponding to a second UE to a target network device, wherein said target network device was not said base station. In various embodiments, wherein said generated handover request acknowledgment includes a parameter indicating that the UE should be informed not to reconnect to a base station from which a handover is being initiated in the event of an initial failure to connect with a base station using the radio resource information supplied to the UE for use in a handover, the base station includes: a reconnection protocol module configured to include in said generated handover request a parameter indicating that the UE should be informed not to reconnect to a base station from which a handover is being initiated in the event of an initial failure to connect with a base station using the radio resource information supplied to the UE for use in a handover. In some embodiments, wherein said generated handover request acknowledgment includes a parameter indicating that the UE should retry to attach to a base station at least once using parameters acquired from broadcast transmissions received from a base station, said retry following the initial handover failure using the faulty radio resource information, said base station includes: a retry protocol module configured to include a parameter indicating that the UE should retry to attach to a base station at least once using parameters acquired from broadcast transmissions received from a base station, said retry following the initial handover failure using the faulty radio resource information.

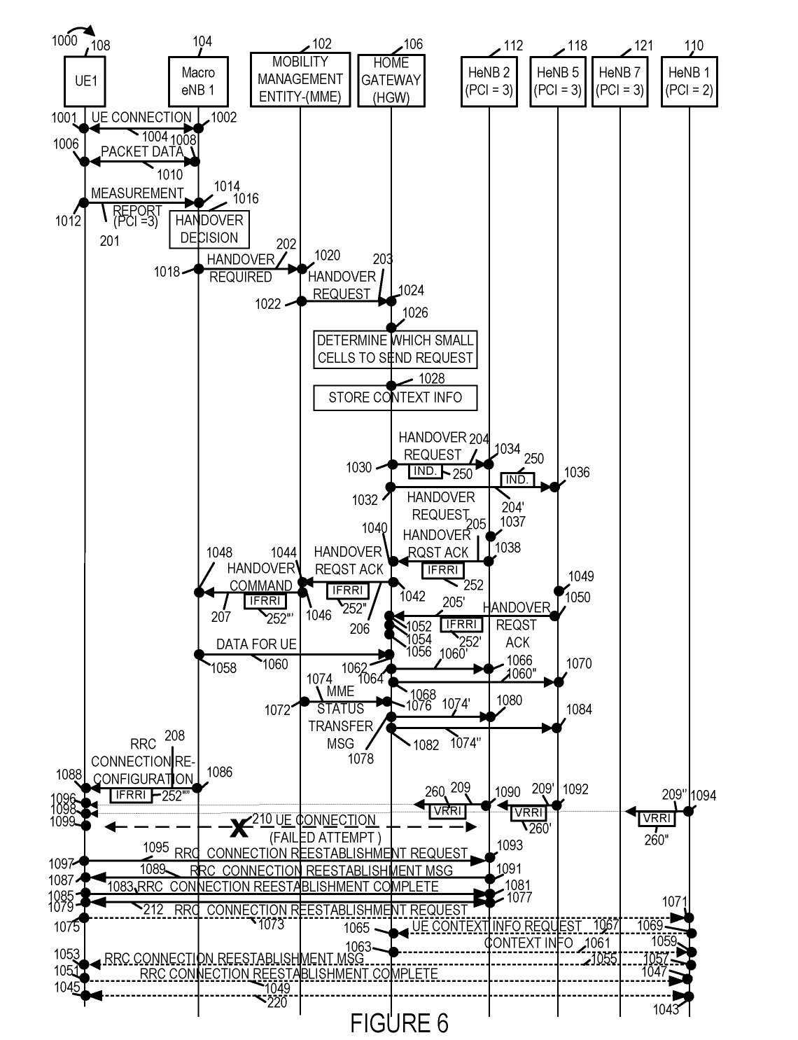

FIG. 6 is a drawing 1000 including exemplary signaling corresponding to the example of FIG. 2 and using the method of flowchart 300 of FIG. 3. Drawing 1000 includes UE 1 108, macro eNB 1 104, e.g., a handover source, MME 102, HeNB (HGW) 106, HeNB 2 112 which uses PCI=3, HeNB 4 118, which uses PCI=3, HeNB 7 121, which uses PCI=3, and HeNB 1 110, which uses PCI=2.

UE 1 108 and macro eNB 1 104 are operated in steps (1001 and 1002), respectively, to establish UE connection 1004. UE 1 108 and macro eNB 1 104 are operated in steps (1006, 1008) to communicate packet data 1010.

In step 1012, UE 1 108 generates and transmits a measurement report 201 including information indicating PCI=3, which is received in step 1014 by macro eNB 1 104. In step 1016, macro eNB 1 104 makes a handover decision based on the measurement report. Macro eNB 1 104 generates and sends handover required signals 202 to MME 102, which is received in step 1020 by MME 102. Based on received handover signal 202, MME 102 generates and sends handover request signal 203 to HGW 106, which receives the handover request 203 in step 1024. The handover request includes a target identifier, e.g., a vECGI.

In step 1026, HGW 106 determines which of the small cells to send the handover request to based on the target identifier, e.g., the vECGI, which is corresponding to multiple small cell base stations. HGW 106 identifies from information in the handover request the source macro base station and identifies a subset of small cell base stations to which the target identifier corresponds. The HGW also identifies which small base stations are in the proximity of the identified source macro base station. In this example, the HGW 106 selects the subset of small cell base stations to be prepared for handover to be HeNB 2 112 and HeNB 5 118.

In step 1028, HGW 106 stores in HGW 106 at least some of the UE context information to be transferred to the selected small base stations to be prepared as potential target small cell base stations for the handover, as part of preparing for handover of the UE 1 108. The at least some UE context information is being stored in case the UE 1 108 selects an HeNB other than one of the target small cell base stations being prepared. Then, the unprepared HeNB can fetch the stored UE context information.

In step 1030 HGW 106 generates and transmits handover request 204 including handover type indicator 250 indicating a type of handover request that should be responded to with intentionally faulty radio resource information to HeNB 2 112, which is received by HeNB 2 112 in step 1034.

In step 1032 HGW 106 generates and transmits handover request 204′ including handover type indicator 250 indicating a type of handover request that should be responded to with intentionally faulty radio resource information to HeNB 5 118, which is received by HeNB 5 118 in step 1036.

In step 1037 HeNB 2 112 determines whether the received handover request 204 should be responded to with valid radio resource information or intentionally faulty radio resource information which if used by the UE 1 108 to attempt a connection to a target base station will result in a failure to connect. As part of step 1037, HeNB 2 112 checks the handover request to determine if the handover request includes a handover type indicator indicating that the handover request should be responded to with intentionally faulty radio resource information. In this example, the checking determines that the handover request 204 includes handover type indicator 250 indicating that the handover request should be responded to with intentionally faulty radio resource information.

In step 1038, HeNB 2 112, generates and sends, in response to determining that the handover request should be responded to with intentionally faulty radio resource information, Handover Request Acknowledgment 205 including intentionally faulty radio resource information (IFRRI) 252, which is received by HGW in step 1040. In some embodiments, the intentionally faulty radio resource information includes a T304 element (timer value) with the smallest possible value permitted in the communications system in which said one or more small base stations are located. In some embodiments, the intentionally faulty radio resource information includes incorrect RACH configuration information.

In step 1042, in response to received signal 1040, HGW 106 sends Handover request acknowledgment 206 including intentionally faulty radio resource information 252″ to MME 102, which is received by the MME 102 in step 1044. In response to received signal 206, the MME 102 generates and sends handover command 207 including intentionally faulty radio resource information 252′″ to macro eNB 104, which is received in step 1048.

In step 1049 HeNB 5 118 determines whether the received handover request 204′ should be responded to with valid radio resource information or intentionally faulty radio resource information which if used by the UE 1 108 to attempt a connection to a target base station will result in a failure to connect. As part of step 1049, HeNB 5 118 checks the handover request to determine if the handover request includes a handover type indicator indicating the handover request should be responded to with intentionally faulty radio resource information. In this example, the checking determines that the handover request 204′ includes handover type indicator 250″ indicating that the handover request should be responded to with intentionally faulty radio resource information.

In step 1050, HeNB 5 118, generates and sends, in response to determining that the handover request should be responded to with intentionally faulty radio resource information, Handover Request Acknowledgment 205′ including intentionally faulty radio resource information (IFRRI) 252′, which is received by HGW in step 1052. In step 1054 HGW 108 determines that an acknowledgment has already been transmitted to MME 102. In step 1056 HGW 106 is operated to refrain from transmitting another acknowledgment to the MME 102.

In step 1058, macro eNB 104 sends data for the UE 1060 to HGW 106 which is received and stored in step 1062. In step 1072 MME 102 sends MME status transfer message 1074 to HGW 106, which is received and stored in step 1062. In various embodiments, the data for the UE and the MME status transfer message were communicated to the HGW prior to the HGW receiving any handover request ACKs, with the data and information waiting, e.g., buffered in the HGW, to be communicated to the small cell base station, e.g., in response to a received handover request ACK.

In step 1064, HGW 106 sends, e.g., in response to received handover request ACK 205, signals 1060′ including data for the UE to HeNB 2 112, which is received in step 1066. In step 1068, HGW 106 sends, e.g., in response to received ACK 205′, signals 1060″ including data for the UE to HeNB 5 118, which is received in step 1070.

In step 1078, HGW 106 sends, e.g., in response to received ACK 205, signal 1074′ including the MME status transfer message to HeNB 2 112, which is received in step 1080. In step 1082, HGW 106 sends, e.g., in response to received ACK 205′, signal 1074″ including the MME status transfer message to HeNB 5 118, which is received in step 1084.

In step 1086 macro eNB 104 transmits RRC Connection Reconfiguration 208 including intentionally faulty radio resource information 252″″ to UE 108, which is received by UE 108 in step 1088.

Various small base stations (HeNB 2 112, HeNB 5 118, HeNB 1 110) which broadcast, in steps (1090, 1092, 1094), valid radio resource information (VRRI) (260, 260′, 260″) in signals (209, 209′, 209″) which can be used by a UE in the proximity of the small base station to establish a radio connection with the a base station, e.g., following the expected failure to connect using the intentionally invalid radio resource information.

In this example, consider that the UE 1 108 decides to attempt to complete the handover to HeNB 2 112 which is one of the HeNBs, which has been prepared for handover. In step 1099, UE 1 108 attempts to complete the handover using the intentionally faulty radio resource information 252″″ which was recovered from received RRC connection reconfiguration signal 208. The attempt to connect using the intentionally faulty radio resource information 252″″ resulting in a failure to connect as indicated by X 210 on the dashed line bi-directional arrow.

In some embodiments, the generated handover request acknowledgment signal 205 includes a parameter indicating that that the UE should be informed not to reconnect to a base station from which a handover is being initiated in the event of an initial failure to connect with a base station using the radio resource information supplied to the UE for use in a handover. In some such embodiments, the parameter or information corresponding to the parameter is conveyed to the UE, e.g., via signals (handover request acknowledgment 206, handover command 207, RRC connection reconfiguration 208).

In some embodiments, the generated handover request acknowledgment signal 205 includes a parameter indicating that the UE should retry to attach to a base station at least once using parameters (valid radio resource information) acquired from broadcast transmissions received from a base station, said retry following the initial handover failure using the faulty radio resource information. In some such embodiments, the parameter or information corresponding to the parameter is conveyed to the UE, e.g., via signals (handover request acknowledgment 206, handover command 207, RRC connection reconfiguration 208).

Following the handover attempt failure indicated by X 210 due to the use of intentionally faulty radio resource information, the UE 108 selects a base station, e.g., which in some embodiments excludes source base station eNB 1 104 based on a received parameter, to attempt to connect using received broadcast radio resource information, which is expected to be valid radio resource information.

Consider that UE 1 108 attempts to connect to HeNB 2 112 using valid radio resource information 260 recovered from received broadcast signal 209. In step 1097, UE 108 generates and sends RRC Connection Reestablishment request 1095, and signal 1095, is received in step 1093 by HeNB 2 112. UE Context information corresponding to UE 1 108 is already stored and available at HeNB 2 112 from the previously received handover request signal 204. In step 1091, HeNB 2 112 generates and sends RRC Connection Reestablishment message 1089 to UE 1 108, which is received in step 1087. In response to received message 1089, UE 1 108 generates and sends, in step 1085, RRC Connection Reestablishment Complete 1083 to HeNB 2 112. In step 1081, HeNB 2 112 receives RRC Connection Reestablishment Complete Message 1083, at which point the RRC connection Reestablishment is officially complete at the new HeNB, which is HeNB 2 112. Connection 212 has established between HeNB 2 112 and UE 1 108, and the devices (112, 108) communicate with each other using established connection 212 in steps 1077 and 1079.

Steps and signaling (1075, 1073, 1071, 1069, 1067, 1065, 1063, 1061, 1059, 1057, 1055, 1053, 1051, 1049, 1047, 1045, 1043, 1041) correspond to an alternative scenario, in which the UE 1 108 is not transitioned to one of the target HeNB (112, 118), e.g., due to a failure or change in channel conditions since the measurement report 201. In this scenario, the UE 108 may instead connect to another one of the small cell base stations, e.g., a small cell base station which was not prepared in advance for handover, e.g., HeNB 1 110, corresponding to PCI=2.

Consider that UE 1 108 attempts to connect to HeNB 1 110 using valid radio resource information 260″ recovered from received broadcast signal 209″. In step 1075, UE 1 108 generates and sends RRC Connection Reestablishment request 1073, and signal 1073, is received in step 1071 by HeNB 1 110. In step 1069, HeNB 1 110 generates and sends a UE Context information request signal 1067, e.g., a UE Context Fetch Request Message, to HGW 106, which is received in step 1065. In step 1063, HGW 106 generates and sends signal 1061, e.g., a UE Context Fetch Response Message, providing at least some stored UE context information to HeNB 1 110, which is received in step 1059. In step 1057, HeNB 1 110 generates and sends RRC Connection Reestablishment message 1055 to UE 1 108, which is received in step 1053. In response to received message 1055, UE 1 108 generates and sends, in step 1051, RRC Connection Reestablishment Complete 1049 to HeNB 1 110. In step 1047, HeNB 1 110 receives RRC Connection Reestablishment Complete Message 1049, at which point the RRC connection Reestablishment is officially complete at the new HeNB, which is HeNB 1 110. Connection 220 has established between HeNB 1 110 and UE 1 108, and the devices (110, 108) communicate with each other using established connection 220 in steps 1045 and 1043.

Various aspects and/or features of some embodiments of the present invention are further discussed below. In some embodiments, the problem of handover with PCI confusion is addressed by implementing a novel method in which a handover failure is forced from the UE's perspective, thereby enabling the UE to trigger RRC Connection Re-Establishment procedure. In some embodiments, the handover failure is facilitated by modifying the Mobility Control Information IE embedded in the target eNB to source eNB transparent RRC container at HeNB and setting the element T304 to the smallest possible value. In some embodiments, RACH parameters are modified to ensure that the random access procedure will not succeed. There are multiple alternative possible variants to RACH parameter modification which may be used. For example, in some embodiments, contention-free random access is used with an assigned preamble, based on RACH parameter modifications, that the target HeNB will intentionally ignore.

In some embodiments, the Handover (HO) failure is forced from the UE's perspective; however, the macro eNB and MME are kept completely unaware of this action making it look like a successful handover to them at the end of the procedure.

In some embodiments, under the assumption that a small cell system is deployed for extending the coverage of the macro cell, i.e., the UE's attempting to enter the small cell system find favorable radio conditions compared to the macro eNB, the particular UE that is being handed in would likely select one of the small cell system HeNBs when performing cell selection prior to RRC Connection Re-Establishment.

In various embodiments, a UE Context Fetch procedure is used, should the UE select an HeNB that doesn't have the UE context, made available during the handover preparation phase.

The techniques of various embodiments may be implemented using software, hardware and/or a combination of software and hardware. Various embodiments are directed to apparatus, e.g., a communications device such as home gateway (HGW), a HGW HandIn Router, various types of access points such as a macro base station, e.g., an eNB, a small cell base station, e.g., a HeNB, a mobility management entity (MME), a serving gateway (SGW), and/or a user equipment (UE) device, etc. Various embodiments are also directed to methods, e.g., a method of operating a communications device such as a home gateway (HGW), a HGW HandIn Router, an macro cell access point, e.g., an eNB, a small cell access point, e.g. a HeNB, a mobility management entity (MME), serving gateway (SGW), and/or a user equipment (UE) device, etc. Various embodiments are also directed to machine, e.g., computer, readable medium, e.g., ROM, RAM, CDs, hard discs, etc., which include machine readable instructions for controlling a machine to implement one or more steps of a method. The computer readable medium is, e.g., non-transitory computer readable medium.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

In various embodiments nodes described herein are implemented using one or more modules to perform the steps corresponding to one or more methods, for example, making a handover type decision, implementing the decision, signal generation, signal transmission, signal reception, signal processing, and/or other steps. Thus, in some embodiments various features are implemented using modules. Such modules may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more nodes. Accordingly, among other things, various embodiments are directed to a machine- readable medium, e.g., a non-transitory computer readable medium, including machine executable instructions for causing a machine, e.g., processor and associated hardware, to perform one or more of the steps of the above-described method(s). Some embodiments are directed to an apparatus, e.g., a communications device such as a gateway, e.g., a Home Gateway (HGW), a HGW HandIn Router, a MME, macro cell base station, e.g., a eNB, a small cell base station, e.g., a HeNB, a SGW, etc., including a processor configured to implement one, multiple or all of the steps of one or more methods of the invention.

In some embodiments, the processor or processors, e.g., CPUs, of one or more devices, e.g., of the communications device, e.g., a gateway such as a HGW, a HGW HandIn Router, a MME, a macro cell base stations such as a eNB, a small cell base station such as a HeNB, SGW, a UE device, etc., are configured to perform the steps of the methods described as being performed by the apparatus. The configuration of the processor may be achieved by using one or more modules, e.g., software modules, to control processor configuration and/or by including hardware in the processor, e.g., hardware modules, to perform the recited steps and/or control processor configuration. Accordingly, some but not all embodiments are directed to a device, e.g., such as communications device, e.g., a gateway such as a HGW, a HGW HandIn Router, a MME, a macro cell base stations such as a eNB, a small cell base station such as a HeNB, SGW, a UE device, etc., with a processor which includes a module corresponding to each of the steps of the various described methods performed by the device in which the processor is included. In some but not all embodiments an apparatus, e.g., a communications device, e.g., a gateway such as a HGW, a HGW HandIn Router, a MME, a macro cell base stations such as a eNB, a small cell base station such as a HeNB, SGW, a UE device, etc., includes a module corresponding to each of the steps of the various described methods performed by the device in which the processor is included. The modules may be implemented using software and/or hardware.

Some embodiments are directed to a computer program product comprising a computer-readable medium, e.g., a non-transitory computer-readable medium, comprising code for causing a computer, or multiple computers, to implement various functions, steps, acts and/or operations, e.g. one or more steps described above. Depending on the embodiment, the computer program product can, and sometimes does, include different code for each step to be performed. Thus, the computer program product may, and sometimes does, include code for each individual step of a method, e.g., a method of controlling a communications device, e.g., a gateway such as a HGW, a HGW HandIn Router, a MME, a macro cell base stations such as a eNB, a small cell base station such as a HeNB, SGW, a UE device, etc. The code may be in the form of machine, e.g., computer, executable instructions stored on a computer-readable medium, e.g., a non-transitory computer-readable medium, such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein.

Numerous additional variations on the methods and apparatus of the various embodiments described above will be apparent to those skilled in the art in view of the above description. Such variations are to be considered within the scope. Numerous additional embodiments, within the scope of the present invention, will be apparent to those of ordinary skill in the art in view of the above description and the claims which follow. Such variations are to be considered within the scope of the invention.

What is claimed is:

1. A handover method, the method comprising:
operating a target network device to receive a handover request corresponding to a UE; and
determining, at the target network device, whether said handover request should be responded to with valid radio resource information or intentionally faulty radio resource information which if used by the UE to attempt a connection to the target base station will result in a failure to connect.

2. The method of claim 1, wherein determining whether said handover request should be responded to with valid radio resource information or intentionally faulty radio resource information includes:
checking said handover request to determine if the handover request includes a handover type indicator indicating a type of handover request that should be responded to with intentionally faulty radio resource information.

3. The method of claim 2, further comprising:
sending, in response to determining that the handover request should be responded to with intentionally faulty radio resource information, a handover request acknowledgment including intentionally faulty radio resource information which if used by the UE to attempt a connection to a target base station will result in a failure to connect.

4. The method of claim 3, further comprising:
operating the target network device to receive context transfer information corresponding to the UE and to store said context transfer information in the event of establishment of a radio connection between said UE and the target network device.

5. The method of claim 3, further comprising:
operating one or more small base stations to broadcast radio resource configuration information which can be used by a UE in proximity to a broadcasting base station to establish a radio connection with the broadcasting base station.

6. The method of claim 5, wherein said target network device is one of said one or more small base stations.

7. The method of claim 6, wherein said handover acknowledgment, sent in response to determining that the handover request should be responded to with intentionally faulty radio resource information, includes a T304 element with the smallest possible value permitted in the communications system in which said one or more small base stations are located.

8. The method of claim 6, wherein said handover acknowledgment, sent in response to determining that the handover request should be responded to with intentionally faulty radio resource information, includes incorrect RACH configuration information.

9. The method of claim 6, further comprising:
operating a destination base station to establish a radio connection with said UE after said UE fails to connect to a base station using said intentionally faulty radio resource information, said destination base station being one of the one or more small base stations that broadcast radio resource configuration information.

10. The method of claim 9, further comprising:
operating the destination base station to obtain context transfer information corresponding to said UE from a network node which communicated the handover request corresponding to the UE to the target network device and which stored said context transfer information pending failure of said UE to connect to the target network device using said faulty radio resource information.

11. The method of claim 3, wherein said handover request acknowledgment includes a parameter indicating that the UE should be informed not to reconnect to a base station from which a handover is being initiated in the event of an initial failure to connect with a base station using the radio resource information supplied to the UE for use in a handover.

12. The method of claim 3, wherein said handover request acknowledgment includes a parameter indicating that the UE should retry to attach to a base station at least once using parameters acquired from broadcast transmissions received from a base station, said retry following the initial handover failure using the faulty radio resource information.

13. A base station comprising:
a handover request receive module configured to receive a handover request corresponding to a UE; and
a handover request type determination module configured to determine whether said handover request should be responded to with valid radio resource information or intentionally faulty radio resource information which if used by the UE to attempt a connection to the target base station will result in a failure to connect.

14. The base station of claim 13, wherein said handover request type determination module includes:
a handover request type indicator checking module configured to check said handover request to determine if the handover request includes a handover type indicator indicating a type of handover request that should be responded to with intentionally faulty radio resource information.

15. The base station of claim 14, further comprising:
a handover request acknowledgment generation module configured to generate, in response to determining that the handover request should be responded to with intentionally faulty radio resource information, a handover request acknowledgment including intentionally faulty radio resource information which if used by the UE to attempt a connection to a target base station will result in a failure to connect; and
a handover request acknowledgment transmission control module configured to control the base station to send, in response to determining that the handover request should be responded to with intentionally faulty radio resource information, the generated handover request acknowledgment including intentionally faulty radio resource information which if used by the UE to attempt a connection to a target base station will result in a failure to connect.

16. The base station of claim 15, further comprising:
a context transfer information receive module configured to receive context transfer information corresponding to the UE; and
a context information storage module configured to store said context transfer information in the event of establishment of a radio connection between said UE and the base station.

17. The base station of claim 15, further comprising:
a radio resource configuration information broadcast control module configured to broadcast radio resource configuration information which can be used by a UE in proximity to the base station to establish a radio connection with the base station.

18. The base station of claim 17, wherein said generated handover acknowledgment, sent in response to determining that the handover request should be responded to with intentionally faulty radio resource information, includes a T304 element with the smallest possible value permitted in the communications system in which said base station is located, the base station further comprising:
a small T304 element inclusion module configured to include in said generated handover request acknowledgment a T304 element with the smallest possible value permitted in the communications system in which said base station is located.

19. The base station of claim 17, wherein said generated handover request acknowledgment, sent in response to determining that the handover request should be responded to with intentionally faulty radio resource information, includes incorrect RACH configuration information, the base station further comprising:
an incorrect RACH configuration information inclusion module configured to include in said generated handover request acknowledgment incorrect RACH configuration information.

20. A non-transitory machine readable medium including processor executable instructions which when executed by a processor of a target network device, control the target network device to perform the steps of:
receiving a handover request corresponding to a UE; and
determining, at the target network device, whether said handover request should be responded to with valid radio resource information or intentionally faulty radio resource information which if used by the UE to attempt a connection to the target base station will result in a failure to connect.
